(19) United States
(12) Patent Application Publication
(10) Pub. No.: US 2022/0035267 A1
(43) Pub. Date: Feb. 3, 2022

(54) POWDER TRANSFER DEVICE, POWDER SUPPLY DEVICE, AND IMAGE FORMING APPARATUS

(71) Applicant: Konica Minolta, Inc., Tokyo (JP)

(72) Inventors: KEITA SAITO, Osaka (JP); ATSUTO HIRAI, Ikoma-shi (JP)

(21) Appl. No.: 17/367,705

(22) Filed: Jul. 6, 2021

(30) Foreign Application Priority Data
Jul. 28, 2020 (JP) 2020-127450

(51) Int. Cl. G03G 15/08; G03G 15/20

(52) U.S. Cl. CPC G03G 15/0856; G03G 15/20

(57) ABSTRACT

A powder transfer device includes: a holder that detachably holds a powder applicator that applies a powder to an image; and a transfer part that transfers the powder onto the image from the powder applicator held by the holder, wherein the powder applicator having the powder adhering to a surface is mounted to the holder.

The entire disclosure of Japanese patent Application No. 2020-127450, filed on Jul. 28, 2020, is incorporated herein by reference in its entirety.

### BACKGROUND

### Technological Field

The present invention relates to a powder transfer device, a powder supply device, and an image forming apparatus.

### Description of the Related Art

In recent years, demand for spot color printing, metallic printing, and high value added printing has increased in the on-demand printing market. Among them, demand for decorative printing such as metallic printing and pearl printing is particularly high, and a wide variety of studies have been conducted.

For example, JP 01-200985 A discloses a method in which a toner image is formed, a foil body having a colorant layer and a pressure-sensitive adhesive layer is superposed on the toner image, and the resultant is heated and pressurized to decorate the toner image using welding by heating of toner. The above document indicates that, with this method, the foil body can be transferred without being wrinkled.

In addition, JP 2014-157249 A discloses a method for forming a metallic image using glitter toner, which is prepared by adding a glitter pigment to toner, only in a necessary portion. The above document indicates that, by using glitter toner, a highly glittering image can be formed even when the applied amount of toner is low.

The applicant of the present invention discloses, in JP 2013-178452 A, a powder transfer device that supplies and adheres (transfers) powder to and onto the surface of an image to decorate the image with the powder. In this method, the powder carried on the surface of a powder supplier is conveyed and supplied to the surface of the image.

In the decorating method as described in JP 2013-178452 A, it is required to reduce powder scattering inside the powder transfer device or from the powder transfer device to the outside thereof. That is, when the powder is supplied to the image, a part of the powder that does not adhere to the image or comes off of the powder supplier scatters inside the powder transfer device, enters components of the device, and impairs the operation of the components.

As a method for suppressing scattering of the powder, it is considered that a suction device is disposed inside the powder transfer device to suction and remove powder which does not adhere to the image or which comes off of the powder supplier. However, in order to provide the suction device inside the powder transfer device, it is necessary to prepare a wide space inside the powder transfer device, which may lead to an increase in size of the powder transfer device. In addition, the cost for the arrangement and operation of the suction device also increases.

### SUMMARY

The present invention has been made based on the above knowledge, and an object of the present invention is to provide: a powder transfer device for forming a decorative image obtained by supplying powder to a surface of an image and decorating the image with the powder, the powder transfer device being capable of suppressing scattering of powder inside the powder transfer device with a simple configuration; a powder supply device that supplies powder to a powder applicator used in the powder transfer device; and an image forming apparatus using the powder transfer device.

To achieve the abovementioned object, according to an aspect of the present invention, a powder transfer device reflecting one aspect of the present invention comprises: a holder that detachably holds a powder applicator that applies a powder to an image; and a transfer part that transfers the powder onto the image from the powder applicator held by the holder, wherein the powder applicator having the powder adhering to a surface is mounted to the holder.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram schematically illustrating a configuration of a powder transfer device according to a first embodiment;

FIG. 2 is a schematic diagram schematically illustrating a configuration of a powder supply device that supplies powder to a powder applicator to be mounted to the powder transfer device illustrated in FIG. 1;

FIG. 3 is a flowchart illustrating a powder transfer method using the powder transfer device and the powder supply device according to the first embodiment;

FIG. 4 is a partial flowchart illustrating a method for supplying powder to the powder applicator in step S100 of the flowchart illustrated in FIG. 3;

FIG. 5 is a partial flowchart illustrating a method for transferring powder to an image in step S200 of the flowchart illustrated in FIG. 3;

FIG. 6 is a schematic diagram schematically illustrating a configuration of a powder transfer device according to a second embodiment;

FIG. 7 is a schematic diagram schematically illustrating a configuration of a powder supply device that supplies powder to a powder applicator to be mounted to the powder transfer device illustrated in FIG. 6;

FIG. 8 is a schematic diagram schematically illustrating a configuration of a powder transfer device according to a third embodiment;

FIG. 9 is a schematic diagram schematically illustrating a configuration of a powder supply device that supplies powder to a powder applicator to be mounted to the powder transfer device illustrated in FIG. 8;

FIG. 10A is a schematic diagram, regarding a fourth embodiment, illustrating the powder applicator in which the powder is supplied to a powder holding surface by the powder supply device in the second embodiment; and

FIG. 10B is a schematic diagram, regarding the fourth embodiment, illustrating the powder applicator in which the powder is supplied to a powder holding surface by the powder supply device in the third embodiment.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

(Configuration of Powder Transfer Device)

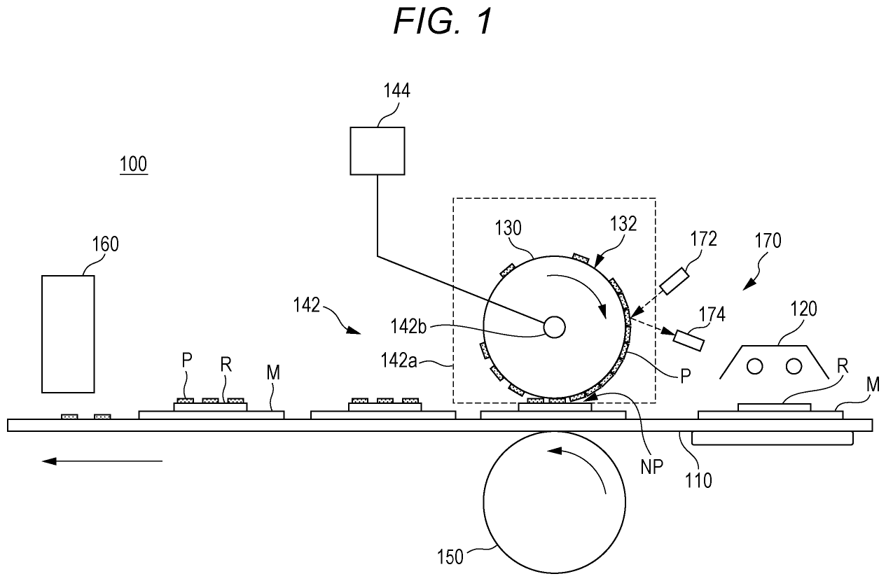

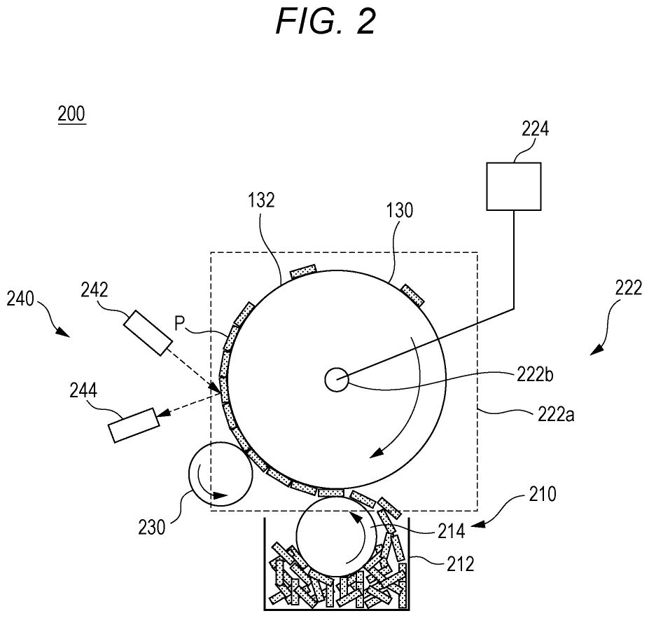

FIG. 1 is a schematic diagram schematically illustrating a configuration of a powder transfer device 100 according to a first embodiment. FIG. 2 is a schematic diagram schematically illustrating a configuration of a powder supply device 200 used together with the powder transfer device 100.

The powder transfer device 100 (see FIG. 1) supplies and adheres powder P to a resin image R formed on the surface of a recording medium M to form a decorative image having the powder P adhering to the surface of the resin image R.

As illustrated in FIG. 1, the powder transfer device 100 includes: a conveyor 110 that conveys the recording medium M on which the resin image R is formed; a softener 120 that softens the resin image R; a powder applicator 130 that conveys the powder P adhering to a powder holding surface 132 and applies the powder P to the resin image R; a holder 142 that rotatably holds the powder applicator 130; a rotation driver 144 that rotates the powder applicator 130 held by the holder 142; a counter member 150 that is provided at a position facing the powder holding surface 132 of the powder applicator 130 across the recording medium M, forms a nip portion NP between the counter member 150 and the powder applicator 130, and presses the recording medium M and the powder P at the nip portion NP; an excess powder collector 160 that collects the powder P adhering to a region other than the resin image R on the recording medium M or the conveyor 110; and a surface detector 170 that detects a surface state of the powder holding surface 132 of the powder applicator 130.

In the present embodiment, the resin image R is an image formed on the surface of the recording medium M with toner, ink, or the like and formed of a thermoplastic resin and an optionally added pigment. In the present embodiment, the powder P is applied from the powder applicator 130 to the resin image R which has been softened by the softener 120, whereby the powder P is adhered to the surface of the softened resin image R to form a decorative image in which the resin image R is decorated with the powder P.

In the present embodiment, the powder P is an aggregate of powder particles. Examples of the powder particles include metal particles, metal oxide particles, resin particles, particles containing a thermally responsive material, magnetic particles, and nonmagnetic particles. These powder particles can be selected according to the decorative image to be obtained. For example, when a decorative image having a metallic feeling is intended to be obtained, powder particles containing metal or metal oxide are preferably used. The powder particles may contain two or more different materials. The shape of the powder particles may be spherical or non-spherical. The powder may be a synthetic product or a commercially available product. The powder may be a mixture of two or more different kinds of powder particles. The powder is not toner.

In addition, the powder particles may be coated. For example, the metal particles may be coated with a metal different from the metal constituting the metal particles, a metal oxide, or a resin, or may be prepared by coating the surface of a resin, glass, or the like with a metal or a metal oxide. The metal particles may be metal oxide particles. The metal oxide particles may be coated with a metal oxide different from the metal oxide constituting the metal oxide particles, metal, or resin. In addition, the metal particles may be those obtained by extending and pulverizing a metal or a metal oxide in a plate shape, those obtained by coating such metal particles with various materials, or those obtained by forming a metal or a metal oxide on a film or glass by vapor deposition or wet-coating. When a metallic image is produced, the powder particles preferably contain 0.2 to 100% by mass of metal or metal oxide.

From the viewpoint of being transferred to the surface of the resin image while being oriented by a rubbing part 230 (described later), the powder preferably has a shape not a true sphere (has a non-spherical shape), for example, a flat shape (flat particles). “Flat particle” means a particle having a shape in which a ratio of a minor axis to a thickness is 3 or more, where a maximum length of a particle of powder is a major axis, a maximum length in a direction orthogonal to the major axis is a minor axis, and a minimum length in a direction orthogonal to the major axis is a thickness. In particular, when the powder P is a metal particle or metal oxide particle, the glossiness of the decorative image can be enhanced by orienting the powder P transferred to the resin image R. When the powder P is oriented, the contact area between the resin image R and the powder P is further increased, so that the powder P is less likely to be separated from the resin image R.

The thickness of the powder particles is preferably 0.2 to 10 μm, and more preferably 0.2 to 3.0 μm from the viewpoint of sufficiently exhibiting the decoration effect due to the adherence of the oriented powder. When the thickness of the powder is in the above range, the powder particles adhering to the surface of the resin image can be sufficiently oriented, and separation of the powder P when the decorative image is rubbed can be suppressed.

The length of each of the major axis and minor axis of the powder particle is preferably 1 to 100 μm, and more preferably 15 to 50 μm. When the lengths of the major axis and minor axis of the powder particle are within the above range, the handleability of the powder is enhanced, and the resolution of the image is sufficiently reduced, so that a decorative image with high gradation can be obtained.

Examples of the powder include: METASHINE (Nippon Sheet Glass Company, Ltd. (“METASHINE” is the registered trademark of this company)); Sunshine Babe Chrome Powder, Aurora powder, and Pearl Powder (GG Corporation); ICEGEL Mirror Metal Powder (TAT Corporation); PIKA-ACE MC Shine Dust and Effect C (Karachi Co., Ltd. (“PIKA-ACE” is the registered trademark of this company)); PREGEL Magic Powder and Mirror series (Preanfa Co., Ltd. (“PREGEL” is the registered trademark of this company)); Bonnail Shine Powder (K's Planning Co. Ltd. (“BONNAIL” is the registered trademark of this company)); ELgee neo (OIKE & Co., Ltd. (“ELgee neo” is the registered trademark of this company)); Astroflake (Nihonboshitsu Co., Ltd.); and aluminum pigment (Toyo Aluminium K.K).

The thermally responsive material indicates a material that causes a change in shape such as expansion, contraction, and deformation, and a change in color such as color development, decoloration, and discoloration in response to stimulation by heat. Examples of particles containing a thermally responsive material include thermally expandable microcapsules, temperature-sensitive capsules, and the like. Examples of thermally expandable microcapsules include Matsumoto Microsphere (Matsumoto Yushi-Seiyaku Co., Ltd) and Kureha Microsphere (Kureha Corporation), and examples of temperature-sensitive capsules include temperature-sensitive dye capsules (Nippon Capsule Products:KK).

In the present embodiment, an aggregate of metal particles is used as the powder P.

In the present embodiment, the recording medium M is not particularly limited as long as a resin image can be formed on its surface (main surface). Examples of the recording medium include plain paper ranging from thin paper to thick paper, high-quality paper, coated printing paper such as art paper and coated paper, commercially available Japanese paper and postcard paper, a plastic film, a resin film, cloth, and the like. Furthermore, the shape and color of the recording medium are not particularly limited, and can be appropriately selected according to the decorative image to be formed.

The conveyor 110 is a unit for conveying the recording medium M having the resin image R formed on the surface thereof to the powder applicator 130. The conveyor 110 can be, for example, a belt conveyor. Note that the conveyor is not limited to the belt conveyor, and may be formed to move the recording medium M while directly supporting the recording medium M by, for example, a support roller or the like.

The softener 120 softens the resin image R. In the present embodiment, the softener 120 preheats the recording medium M on which the resin image R is formed by an oven to soften (melt) the resin constituting the resin image R, thereby softening the resin image R. The softener 120 may preheat the resin image in a non-contact manner using, for example, a hot plate or a hot air blower, or preheat the resin image in a contact manner using, for example, a heat roller. When the resin image R is at a higher temperature, the softener 120 may cool the resin image R to a temperature suitable for decoration, or soften the resin image by applying a chemical or the like.

The powder applicator 130 is a cylindrical member that rotates in a direction along the conveyance direction (arrow) of the recording medium M about a cylindrical shaft by a drive motor, and has a cylindrical side peripheral surface as a powder holding surface 132 having tackiness. The powder applicator 130 holds the powder P on the tacky powder holding surface 132 by tackiness, and conveys the powder P to the nip portion NP. In the present embodiment, the powder applicator 130 is a cylindrical member in which silicone rubber “RBAM2-100” (manufactured by MISUMI Corporation) having a thickness of 2 mm and a Shore A hardness of 53 is provided on the surface of a roller having an outer diameter of 100 mm.

The powder holding surface 132 may have a tack value lower than that of the resin image R softened by the softener 120. For example, the powder holding surface 132 preferably has a tack strength (also referred to as adhesive force) of 28 kPa or more. The powder holding surface 132 preferably has a tack strength that allows the powder P to be transferred to the resin image R from the powder holding surface 132 when the adhering powder P comes into contact with the softened resin image R. From this viewpoint, the tack strength of the powder holding surface 132 is preferably 470 kPa or less, and more preferably 350 kPa or less. Examples of the material constituting the powder holding surface 132 include fluorine-containing rubber, silicone rubber, and urethane rubber.

The material constituting the powder holding surface 132 is not limited to the rubber material, and may be another resin material or metal material as long as it has a tack strength capable of carrying the powder.

The tack strength can be measured using a tacking tester “FSR-1000” (manufactured by RHESCA Co., Ltd.). A force required for removing a tip of a probe which is pressed against the surface of a sample can be measured as the tack strength. For example, the tack strength can be measured under the following conditions.

The tack strength can be converted into a pressure based on the area of the tip of the probe.

(Measurement Conditions)
(1) Probe diameter: 10 mm in diameter
(2) Pressing speed: 5 mm/sec
(3) Pressing pressure: 50 kPa
(4) Pressing holding time: 1 second
(5) Probe pulling speed: 5 mm/sec
(6) Measurement temperature: 20° C.

The powder applicator 130 is detachably mounted on the downstream side of the softener 120 on the conveyance path of the recording medium M and on the main surface side of the recording medium M on which the resin image R is formed. When the softener 120 softens the resin image R by heating, the heat from the resin image R is also transmitted to the powder applicator 130. In view of this, the material constituting the powder holding surface 132 preferably has heat resistance. From such a viewpoint, silicone rubber (tack strength: 82 kPa) is preferable among the rubber materials described above.

The holder 142 holds the powder applicator 130 and attaches the powder applicator 130 to the powder transfer device 100. The holder 142 includes a space 142a in which the powder applicator 130 is disposed, and a holding member 142b that rotatably holds the powder applicator 130. In the present embodiment, the holding member 142b is a bearing that rotatably holds the shaft of the powder applicator 130. The holder 142 holds the powder applicator 130 at a position where the powder holding surface 132 of the rotating powder applicator 130 can contact the resin image conveyed by the conveyor 110.

The rotation driver 144 rotates the powder applicator 130 held by the holder 142. In the present embodiment, the rotation driver 144 rotates the powder applicator 130 by rotating the holding member 142b (bearing that holds the shaft of the powder applicator 130). When the rotation driver 144 rotates the powder applicator 130, the powder P is transferred from the rotating powder holding surface 132 of the powder applicator 130 to the resin image R that moves on the conveyor 110.

The counter member 150 presses the recording medium M and the powder applicator 130 toward each other at the nip portion NP to transfer the powder P held on the powder holding surface 132 of the powder applicator 130 to the resin image R formed on the main surface of the recording medium M. At this time, since the resin image R has been softened by the softener 120 and exhibits tackiness, the powder P can be transferred, adhered, and held by pressure when passing through the nip portion NP. The counter member 150 is also a transfer part in the present embodiment. Note that the counter member 150 may be rotated in synchronization with the powder applicator 130 by the rotation driver 144, or may be rotated independently of the powder applicator 130 by a driver different from the rotation driver 144.

The excess powder collector 160 collects an excess powder P applied from the powder applicator 130 to the recording medium M or the conveyor 110 in the nip portion NP but not adhering to and held on the resin image R. The excess powder collector 160 is disposed on the downstream side of the nip portion NP in the conveyance direction of the recording medium M by the conveyor 110 and on the surface (main surface) side of the recording medium M where the resin image R is formed.

The excess powder collector 160 may suction the powder P by, for example, air suction, but the configuration of the excess powder collector 160 is not limited thereto.

The surface detector 170 detects a surface state of the powder holding surface 132 of the powder applicator 130. In the present embodiment, the surface detector 170 detects whether or not powders are applied to the powder holding surface 132 and whether or not powders are applied to the powder holding surface 132 without overlapping each other.

The surface detector 170 is an optical sensor that optically measures the surface state of the powder holding surface 132, and includes a light emitter 172 that irradiates the powder holding surface 132 with light of a predetermined wavelength in a predetermined amount, and a light receiver 174 that receives regular reflection light emitted from the light emitter 172 and regularly reflected by the powder holding surface 132 and measures an amount of the regular reflection light.

At this time, the amount of light measured by the light receiver 174 increases or decreases depending on the amount of the powders P (metal particles) held on the powder holding surface 132. For example, when the powder holding surface 132 holds the powder P, the amount of light measured by the light receiver 174 is larger, and when the powder holding surface 132 does not hold the powder P, the amount of light measured by the light receiver 174 is smaller. When the powders P overlap each other on the powder holding surface 132, the amount of light measured by the light receiver 174 changes for each region of the powder holding surface 132. The surface detector 170 can detect the amount and adherence state of powders held on the powder holding surface 132 on the basis of the amount of regular reflection light measured by the light receiver 174. In the present embodiment, a white LED is used as the light emitter 172, and a photodiode is used as the light receiver 174.

(Configuration of Powder Supply Device)

The powder supply device 200 (see FIG. 2) supplies powders P to the powder applicator 130 detached from the powder transfer device 100 so that the powders P are held on the powder holding surface 132 without overlapping each other.

The powder supply device 200 includes: a holder 222 that rotatably holds the powder applicator 130; a rotation driver 224 that rotates the powder applicator 130 held by the holder 222; a powder supplier 210 that supplies the powder P to the powder applicator 130 held by the holder 222; a rubbing part 230 that orients the powder P supplied from the powder supplier 210 to the powder applicator 130 on the surface of the powder applicator 130; and an adherence detector 240.

The holder 222 holds the powder applicator 130 and attaches the powder applicator 130 to the powder supply device 200. The holder 222 includes a space 222a in which the powder applicator 130 is disposed, and a holding member 222b that rotatably holds the powder applicator 130. In the present embodiment, the holding member 222b is a bearing that rotatably holds the shaft of the powder applicator 130. The holder 222 holds the powder applicator 130 at a position where the powder holding surface 132 of the rotating powder applicator 130 can contact the rotating rubbing part 230.

The rotation driver 224 rotates the powder applicator 130 held by the holder 222. In the present embodiment, the rotation driver 224 rotates the powder applicator 130 by rotating the holding member 222b (bearing that holds the shaft of the powder applicator 130).

The powder supplier 210 supplies the powder P to the powder holding surface 132 of the powder applicator 130. The powder supplier 210 includes a storage container 212 that stores the powder P, and a conveyance member 214 housed in the storage container 212.

The storage container 212 has an opening formed along the axial direction of the powder holding surface 132 of the cylindrical powder applicator 130.

The conveyance member 214 is a cylindrical rubber, brush, or sponge that is rotatable, and rotates in a direction opposite to the rotation direction of the powder applicator 130 inside the storage container 212, thereby conveying the powder P stored in the storage container 212 to the opening of the storage container 212 and supplying the powder P to the powder holding surface 132 of the powder applicator 130.

The powder supplier 210 is not limited to having the above configuration. For example, the powder supplier 210 may bring the powder P stored in the storage container 212 into direct contact with the powder holding surface 132 of the powder applicator 130.

As illustrated in FIG. 2, the powder supplier 210 applies the powder P to the powder applicator 130 from below in the vertical direction. By applying the powder P to the powder applicator 130 from below in the vertical direction, the powder not adhering to the powder holding surface 132 can be collected into the storage container 212, so that scattering of the powder P inside the powder supply device 200 can be prevented.

The rubbing part 230 is disposed on the downstream side of the powder supplier 210 with respect to the rotation direction of the powder applicator 130. The rubbing part 230 rotates about a cylindrical shaft while in contact with the powder holding surface 132 of the powder applicator 130, thereby rubbing the powder holding surface 132. The rubbing part 230 may have a cylindrical shape, an elliptical cylindrical shape, a polygonal columnar shape, or the like, but preferably has a cylindrical shape.

The rubbing part 230 rotates in the direction same as the direction of the powder applicator 130 while in contact with the powder holding surface 132 of the powder applicator 130. Thus, the rubbing part 230 rubs the powder holding surface 132. The side peripheral surface of the rubbing part 230 that rubs the powder holding surface 132 is preferably made of a material having pores for accommodating the powder P. Examples of such materials include a porous material such as a brush, a sponge, and nonwoven fabric. When the rubbing part 230 having pores rubs the powder holding surface 132 of the rotating powder applicator 130, the excess powder P not adhering to the powder holding surface 132 can be captured and removed in the pores. From the above viewpoint, the rubbing part 230 may include a powder collector (not illustrated) that collects the removed powder. The powder collector may be of an air suction type, or may have a configuration in which a member such as a roller or a blade is brought into contact with the side peripheral surface of the rubbing part 230, and the powder P is ejected from the pore by the restoring force of the material constituting the side peripheral surface of the rubbing part 230.

In this case, the rubbing part 230 can continuously convey the powder P captured and accommodated in the pore in the rotation direction, because it rotates around the cylindrical shaft. Thus, the excess powder P can be removed from the powder holding surface 132 without being accumulated at the nip portion between the powder holding surface 132 and the rubbing part 230. Accordingly, the rubbing property of the powder holding surface 132 by the rubbing part 230 can be stabilized.

By the rubbing of the rubbing part 230, one layer of the powder P remains directly adhered to the powder holding surface 132. At this time, if the powder P has a non-spherical shape, it is also possible to align (orient) the orientation of the powder P with respect to the powder holding surface 132 by rubbing of the rubbing part 230. As a result, the powder P can be transferred from the powder holding surface 132 to the resin image R in an oriented state.

At this time, since the rotation direction of the rubbing part 230 is the same as the rotation direction of the powder applicator 130, the relative speed (rubbing speed) of the rubbing part 230 with respect to the powder applicator 130 can be further increased to further enhance the rubbing effect. However, as long as the powder holding surface 132 can be rubbed by a relative speed difference from the rotating powder applicator 130, the rubbing part 230 may not be rotating or may be rotating at a speed different from that of the powder applicator 130 in the opposite direction.

The pressing force of the rubbing part 230 against the powder holding surface 132 of the powder applicator 130 is preferably 1 to 10 kPa, and more preferably 1 to 5 kPa. Within the above range, it is possible to stably rub the powder holding surface 132 of the powder applicator 130, and to prevent the occurrence of uneven driving of the rubbing part 230 and deterioration of the materials of the rubbing part 230 and the powder applicator 130 due to an excessive torque for rotating the rubbing part 230.

The adherence detector 240 is an optical sensor that optically measures the surface state of the powder holding surface 132, and includes a light emitter 242 that irradiates the powder holding surface 132 with light of a predetermined wavelength in a predetermined amount, and a light receiver 244 that receives regular reflection light emitted from the light emitter 242 and regularly reflected by the powder holding surface 132 and measures an amount of the regular reflection light.

At this time, the amount of light measured by the light receiver 244 increases or decreases depending on the amount of the powders P (metal particles) held on the powder holding surface 132. For example, when the powder holding surface 132 holds the powder P, the amount of light measured by the light receiver 244 is larger, and when the powder holding surface 132 does not hold the powder P, the amount of light measured by the light receiver 244 is smaller. When the powders P overlap each other on the powder holding surface 132, the amount of light measured by the light receiver 174 changes for each region of the powder holding surface 132. The adherence detector 240 can detect the amount and adherence state of powders held on the powder holding surface 132 on the basis of the amount of regular reflection light measured by the light receiver 244. In the present embodiment, a white LED is used as the light emitter 242, and a photodiode is used as the light receiver 244.

(Powder Transfer Method)

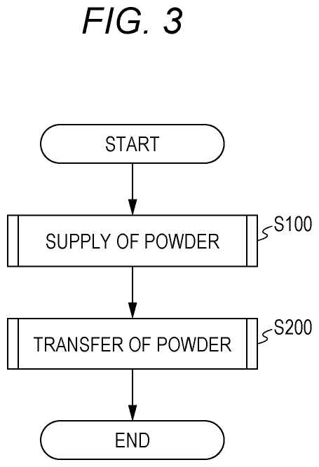

FIG. 3 is a flowchart illustrating a powder transfer method using the powder transfer device 100 and the powder supply device 200 according to the present embodiment.

The powder transfer method according to the present embodiment includes steps of: supplying the powder to the powder applicator 130 (step S100); and transferring the powder to the resin image (step S200). The step of supplying the powder (step S100) is performed by the powder supply device 200, and the step of transferring the powder (step S200) is performed by the powder transfer device 100.

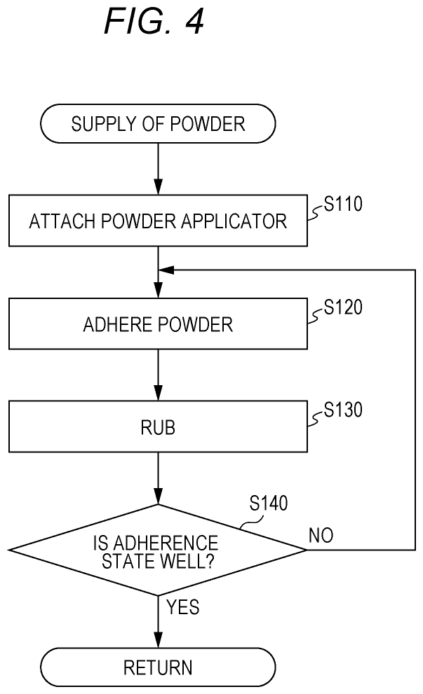

FIG. 4 is a partial flowchart illustrating a method for supplying powder to the powder applicator 130 in step S100. Each of the following steps is performed by each functional unit under the control of a control unit (not illustrated) included in the powder supply device 200.

In step S100, first, the powder applicator 130 is mounted to the holder 222 of the powder supply device 200 (step S110).

Specifically, the powder applicator 130 is moved to the space 222a of the holder 222, and the rotation shaft of the powder applicator 130 is attached to the holding member 222b that is a bearing. When attached, the powder applicator 130 is disposed at a position where the powder holding surface 132 is in contact with the rubbing part 230.

Next, the powder P is adhered to the powder holding surface 132 (step S120).

Specifically, the rotation driver 224 rotates the holder 222 to rotate the powder applicator 130 held by the holder 222. At the same time, the conveyance member 214 of the powder supplier 210 rotates to move the powder P stored in the powder supplier 210 to the powder holding surface 132 of the powder applicator 130 which is rotating The powder P moved to the powder holding surface 132 by the rotation of the conveyance member 214 adheres to the powder holding surface 132 due to the tackiness of the powder holding surface 132. As the powder P is continuously moved from the rotating conveyance member 214 to the powder holding surface 132 of the rotating powder applicator 130, the powder P adheres to the powder holding surface 132. In FIG. 2, the rotation direction of the conveyance member 214 is opposite to the rotation direction of the powder applicator 130, but the conveyance member 214 may be rotated in the same direction as the powder applicator 130.

Next, the powder P adhering to the powder holding surface 132 is rubbed (step S130).

Specifically, the rubbing part 230 is rotated while the powder applicator 130 is rotated by the rotation driver 224. As a result, the powders P adhering to the powder holding surface 132 can be oriented and adhered without overlapping each other. This step may be performed after completion of the step of adhering the powder P to the powder holding surface 132 (step S120), but from the viewpoint of further improving the work efficiency, this step is preferably performed simultaneously with the step of adhering the powder P to the powder holding surface 132 (step S120).

Finally, the state of adherence of the powder P to the powder holding surface 132 is detected, and it is determined whether or not the powder P adheres well (step S140).

Specifically, the adherence detector 240 detects the surface state of the powder holding surface 132 which has been rubbed by the rubbing part 230. If it is determined that the powder P adheres well to the powder holding surface 132 on the basis of the detection result (step S140: YES), the partial flowchart ends. On the other hand, if it is not determined that the powder P adheres well to the powder holding surface (step S140: NO), the step (step S120) of adhering the powder P to the powder holding surface 132 and the step (step S130) of rubbing the powder P are performed again.

In the present embodiment, the state in which the powder P adheres well to the powder holding surface 132 indicates a state in which a sufficient amount of powders P is held on the surface of the powder holding surface 132 and the powders P are held without overlapping each other. It is possible to determine in step S140 whether or not the powder P adheres well to the powder holding surface 132 on the basis of the amount of light received by the light receiver 244 with respect to the light emitted by the light emitter 242 of the adherence detector 240. For example, when the amount of powders P held on the surface of the powder holding surface 132 is small, the amount of light received by the light receiver 244 decreases. When the powders are held while overlapping each other on the powder holding surface 132, the amount of light received by the light receiver 244 from the overlapping region is increased or decreased as compared with the amount of light received by the light receiver 244 from another region. Therefore, when the powder P does not adhere well to the powder holding surface 132, the spatial distribution or the frequency distribution of the light received by the light receiver 244 varies. Accordingly, in the present embodiment, it may be determined that the powder P adheres well to the powder holding surface 132 when there is no variation in the spatial distribution or the frequency distribution, and it may be determined that the powder P does not adhere well to the powder holding surface 132 when there is a variation in the spatial distribution or the frequency distribution.

According to the knowledge of the inventors of the present invention, when the powder P is applied to an area of 40 to 60% of the surface area of the surface of the powder holding surface 132 to which the powder P is applied, the powders P in an amount that can be sufficiently transferred to the resin image R are held, and they are likely to be held without overlapping each other.

After the step of transferring the powder (step S200) is performed, the powder applicator 130 is in a state in which the powder holding surface 132 has no powder in a region where the powder has been transferred, whereas it has remaining powders in a region where the powder has not been transferred. When the powder supply device 200 supplies the powder P to the powder applicator 130 again at the time of subsequent transfer of the powder using the powder applicator 130 in this state, the powder applicator 130 may have both a region where the powders P adhere without overlapping each other and a region where the powders P do not adhere or adhere while overlapping each other. When the next transfer of powder is performed using the powder applicator 130 in such a state, the powder P is not sufficiently transferred or excessively transferred to the resin image R, and it is difficult to decorate the resin image R to a desired degree. On the other hand, when the powder applicator 130 which is confirmed by the adherence detector 240 that the powder P adheres well is used for the next transfer of powder, the abovementioned transfer failure of the powder P is less likely to occur.

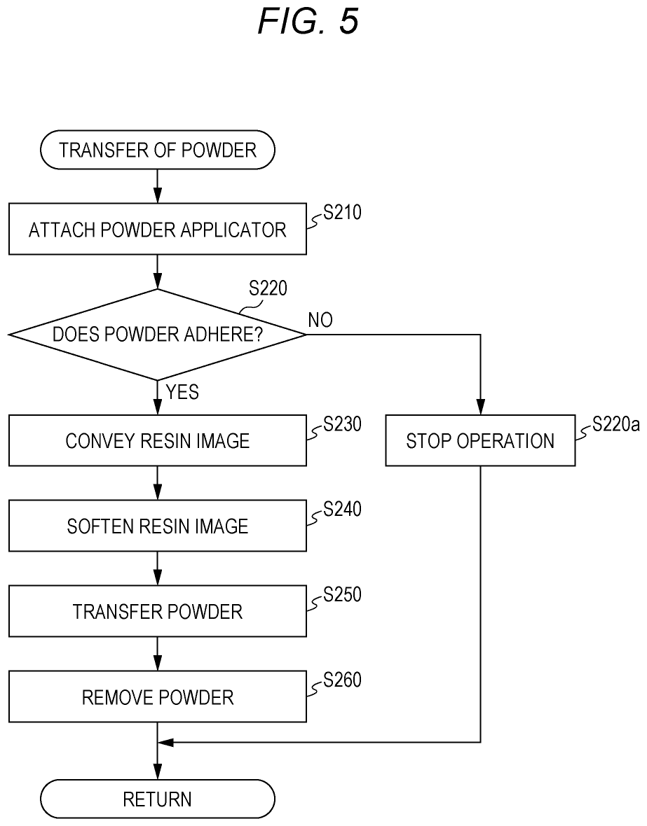

FIG. 5 is a partial flowchart illustrating a method for transferring powder to the resin image R in step S200.

First, the powder applicator 130 having powder supplied to the powder holding surface 132 in step S100 is mounted to the holder 142 of the powder transfer device 100 (step S210).

Specifically, the powder applicator 130 is moved to the space 142a of the holder 142, and the rotation shaft of the powder applicator 130 is attached to the holding member 142b that is a bearing. When attached, the powder applicator 130 is disposed at a position where the powder holding surface 132 can contact the resin image R conveyed by the conveyor 110.

Next, it is determined whether or not the mounted powder applicator 130 has the powder P adhering well to the powder holding surface 132 (step S220).

Specifically, the surface detector 170 detects the surface state of the powder holding surface 132 of the powder applicator 130 mounted to the holder 142. Whether the powder P adheres well to the powder holding surface 132 can be determined in the same manner as the determination of whether the powder P adheres well in the powder supply device 200 (step S140). If it is determined that the powder P adheres well to the powder holding surface 132 on the basis of the detection result (step S220: YES), the partial flowchart ends. On the other hand, if it is not determined that the powder P adheres well to the powder holding surface (step S220: NO), the powder transfer device 100 stops the operation, and does not execute the subsequent steps (step S220a). At this time, the powder transfer device 100 may notify an operator of information indicating that the powder P does not adhere to the powder holding surface by, for example, displaying an error on a display (not illustrated).

In other words, when it is determined in this step that the powder P does not adhere to the powder holding surface 132, the conveyor 110 does not convey the resin image R, or the mounted powder applicator 130 does not apply the powder P to the resin image R.

Next, the resin image R is conveyed (step S230).

Specifically, the recording medium M on which the resin image R is formed is placed on the conveyor 110, and the conveyor 110 is driven. Thus, the resin image R is moved to the nip portion NP formed by the powder applicator 130 and the counter member 150.

Next, the resin image is softened (step S240).

Specifically, the resin image R being conveyed is heated by the softener 120 which is an oven. With this process, the resin constituting the resin image R is softened (melted), and thus, the resin image R is softened. The softening method is not limited thereto, and the resin image R may be softened by a method corresponding to the configuration of the softener 120.

Next, the powder is transferred to the resin image (step S250).

Specifically, the rotation driver 144 rotates the holder 142 to rotate the powder applicator 130 held by the holder 142. Then, the softened resin image R passes through the nip portion NP formed by the powder applicator 130 and the counter member 150. As a result, the powder P is applied from the powder applicator 130 (powder holding surface 132) to the resin image R, and the powder P is fixed on the resin image R, due to the adherence of the powder P onto the softened resin image R and pressure at the nip portion NP. In this manner, the powder P is transferred from the powder holding surface 132 to the resin image R.

Finally, the excess powder P is removed from the recording medium M or the conveyor 110 (step S260).

Specifically, the excess powder collector 160 collects and removes the powder P applied to the recording medium M or the conveyor 110 but not fixed to the resin image R by air suction. The method for removing the powder P is not limited to the above method, and the powder P may be removed from the recording medium M or the conveyor 110 by a method corresponding to the configuration of the excess powder collector 160.

In this manner, the powder P is transferred and fixed, and the resin image R decorated with the powder P can be obtained.

(Effects)

According to the present embodiment configured as described above, the powder transfer device 100 does not include the powder applicator. The powder P can be transferred to the resin image R with a simple configuration without supplying the powder P to the powder applicator 130 inside the powder transfer device 100, whereby scattering of the powder P inside the powder transfer device 100 can be suppressed.

(Modification)

In step S220, instead of determining whether or not the powder P adheres well to the powder holding surface 132, the powder transfer device 100 may only determine whether or not the powder P adheres to the powder holding surface 132. Whether or not the powder P adheres to the powder holding surface 132 can be determined by whether or not the amount of light received by the light receiver 174 has changed with respect to the amount of light received by the light receiver 174 when the light emitter 172 irradiates the powder holding surface 132 having no powder P adhering thereto with light.

The criterion for determination in step S220 may be changed according to the quality of the decorative image to be formed, the cost and efficiency of work, and the like.

### Second Embodiment

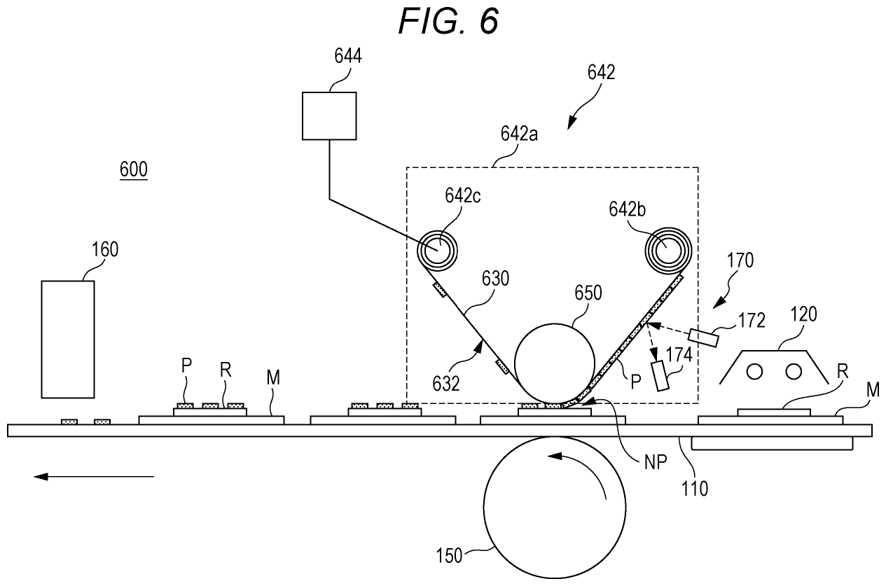

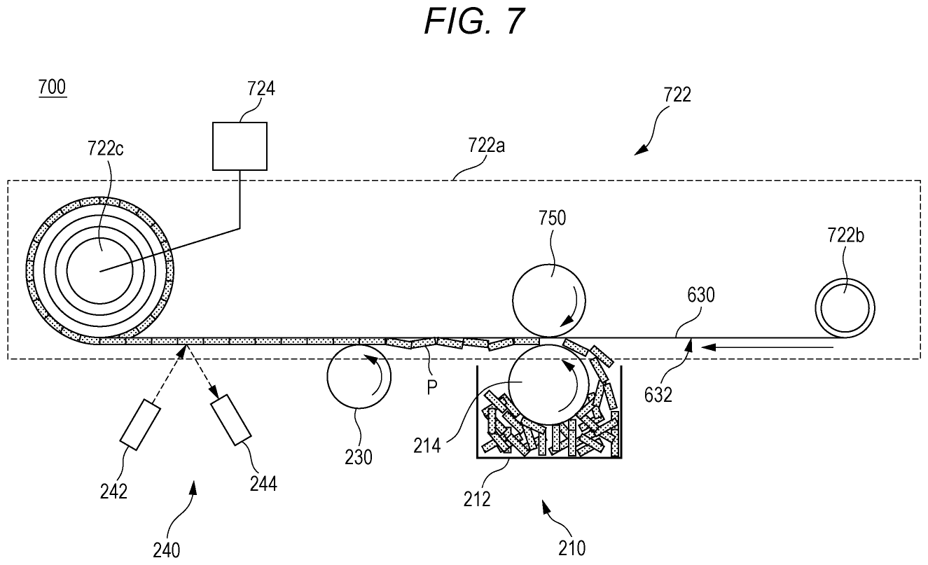

FIG. 6 is a schematic diagram schematically illustrating a configuration of a powder transfer device 600 according to a second embodiment, and FIG. 7 is a schematic diagram schematically illustrating a configuration of a powder supply device 700 that supplies powder to a powder applicator 630 mounted to the powder transfer device 600.

The second embodiment is different from the first embodiment in that the powder applicator 630 has a sheet shape or a web shape. Other configurations of the powder transfer device 600 and the powder supply device 700 may be similar to those of the powder transfer device 100 and the powder supply device 200 in the first embodiment, respectively, and thus the detailed description thereof will be omitted. In addition, the powder transfer method in the second embodiment may be similar to the powder transfer method in the first embodiment, and thus the detailed description thereof will be omitted.

In the present embodiment, a holder 642 of the powder transfer device 600 includes a space 642a in which the powder applicator 630 is disposed, a holding member 642b that holds one end of the powder applicator 630 having a sheet shape or a web shape, and a holding member 642c that holds the other end of the powder applicator 630. One or both of the holding member 642b and the holding member 642c (the holding member 642c in FIG. 6) are rotated by a rotation driver 644. The powder transfer device 600 also includes a contact member 650 that brings a powder holding surface 632 of the powder applicator 630 into contact with the resin image R. In the present embodiment, the contact member 650 is a rotating roller.

When the rotation driver 644 rotates the holding member 642c, the sheet-shaped or web-shaped powder applicator 630 wound around and held by the holding member 642b is fed out from the holding member 642b, passes through the nip portion NP formed by the counter member 150 and the contact member 650, and is taken up by the holding member 642b. The counter member 150 and the contact member 650 also correspond to the transfer part in the present embodiment.

At this time, the counter member 150 and the contact member 650 press the recording medium M and the powder applicator 630 toward each other at the nip portion NP to transfer the powder P held on the powder holding surface 632 of the powder applicator 630 to the resin image R formed on the main surface of the recording medium M. Then, the powder P is transferred from the powder applicator 630 to the resin image R, which has been softened by the softener 120 and exhibits tackiness, and adhered and held thereon with the pressure applied during passage through the nip portion NP.

In addition, as in the first embodiment, the surface detector 170 may detect the amount and adherence state of powders held on the powder holding surface 632 of the powder applicator 630 disposed in the powder transfer device 600, and when the powders P do not adhere or the powders P overlap each other, application of the powders P to the resin image R may not be performed.

In the powder supply device 700, a holder 722 includes a space 722a in which the powder applicator 630 is disposed, a holding member 722b that holds one end of the powder applicator 630 having a sheet shape or a web shape, and a holding member 722c that holds the other end of the powder applicator 630. One or both of the holding member 722b and the holding member 722c (the holding member 722c in FIG. 7) are rotated by a rotation driver 724.

When the rotation driver 724 rotates the holding member 722c, the sheet-shaped or web-shaped powder applicator 630 wound around and held by the holding member 722b is fed out from the holding member 722b, is supplied with the powder P onto the powder holding surface 632 from the powder supplier 210, and is taken up by the holding member 722c after the powder P is rubbed by the rubbing part 230. In this manner, the powder P is applied and oriented on the powder holding surface 632 having tackiness. In the present embodiment, the counter member 750 is disposed at a position where the powder applicator 630 faces the conveyance member 214 of the powder supplier 210, and the powder applicator 630 and the powder P are pressed by the conveyance member 214 and the counter member 750, whereby the powder P reliably adheres to the powder applicator 630.

In the present embodiment, the adherence detector 240 detects the amount and adherence state of the powders held on the powder holding surface 632, and the powder supply device 700 stops feeding of the powder when the powders P do not adhere or the powders P overlap with each other. Alternatively, when the powders P do not adhere or the powders P overlap each other, the rotation driver 724 may rotate the holding member 722c in the opposite direction to rewind the powder applicator 630, and the powder may be supplied and rubbed again.

(Effects)

According to the present embodiment thus configured, even when the sheet-shaped or web-shaped powder applicator 630 is used, the powder P can be transferred to the resin image R with a simple configuration without supplying the powder P to the powder applicator 630 inside the powder transfer device 600, whereby scattering of the powder P inside the powder transfer device 600 can be suppressed.

### Third Embodiment

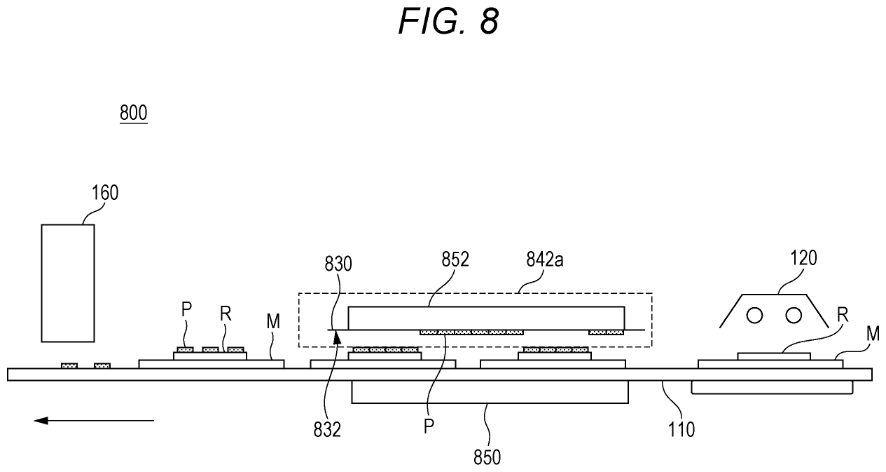

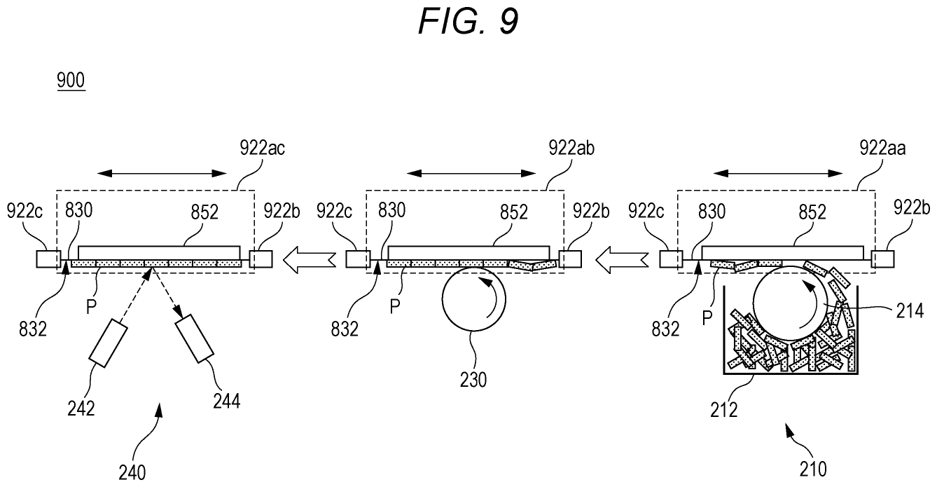

FIG. 8 is a schematic diagram schematically illustrating a configuration of a powder transfer device 800 according to a third embodiment, and FIG. 9 is a schematic diagram schematically illustrating a configuration of a powder supply device 900 that supplies powder to a powder applicator 830 mounted to the powder transfer device 800.

The third embodiment is different from the first embodiment and the second embodiment in that the powder applicator 830 has a cut sheet shape. Other configurations of the powder transfer device 800 and the powder supply device 900 may be similar to those of the powder transfer device 100 and the powder supply device 200 in the first embodiment and the powder transfer device 600 and the powder supply device 700 in the second embodiment, respectively, and thus the detailed description thereof will be omitted. In addition, the powder transfer method in the third embodiment may be similar to the powder transfer method in the first or second embodiment, and thus the detailed description thereof will be omitted.

In the present embodiment, the powder transfer device 800 includes a space 842a in which the powder applicator 830 is disposed, and a contact member 852 that brings a powder holding surface 832 of the powder applicator 830 having a cut sheet shape into contact with the resin image R.

In the powder transfer device 800, a flat plate-shaped counter member 850 is disposed at a position facing the contact member 852 with the resin image R interposed therebetween. Then, by pressing the powder applicator 830 to the resin image R by the contact member 852 and the counter member 850, the powder P is transferred from the powder applicator 830 to the resin image R, which has been softened by the softener 120 and exhibits tackiness, and adhered and held thereon. The counter member 850 and the contact member 852 also correspond to the transfer part in the present embodiment.

In the present embodiment as well, a surface detector (not illustrated) may detect the amount and adherence state of powders held on the powder holding surface 832 of the powder applicator 830 disposed in the powder transfer device 800, and when the powders P do not adhere or the powders P overlap each other, application of the powder P to the resin image R may not be performed, as in the first embodiment.

In the powder supply device 900, a holder 922 includes spaces 922aa, 922ab, and 922ac in which the powder applicator 830 is disposed, a holding member 922b that holds one end of the powder applicator 830 having a cut sheet shape, and a holding member 922c that holds the other end of the powder applicator 830. The holding member 922b and the holding member 922c are biased in a direction away from each other while holding the powder applicator 830, and apply a predetermined tension to the powder applicator 830.

In the present embodiment, the powder applicator 830 and the contact member 852 are integrally removed from the powder transfer device 800 and mounted to the powder supply device 900. Such a configuration facilitates removal of the powder applicator 830 from the powder transfer device 800 and attachment of the powder applicator 830 to the powder transfer device 800.

In this state, the powder P is supplied to the powder holding surface 832 of the powder applicator 830 by the powder supplier 210, and rubbed by the rubbing part 230. In this manner, the powder P is applied and oriented on the powder holding surface 832 having tackiness. In the present embodiment, a counter member (not illustrated) may be disposed at a position where the powder applicator 830 faces the conveyance member 214 of the powder supplier 210, and the powder applicator 830 and the powder P may be pressed by the conveyance member 214 and the counter member so that the powder P reliably adheres to the powder applicator 830. At this time, the holding member 922b and the holding member 922c move the powder applicator 830 with respect to the powder supplier 210 and the rubbing part 230 so that the powder P adheres to a wide range of the powder holding surface 832. Note that the powder supplier 210 and the rubbing part 230 may be moved instead of the powder applicator 830.

In the present embodiment as well, the adherence detector 240 detects the amount and adherence state of the powders held on the powder holding surface 832, and the powder supply device 900 stops feeding of the powder when the powders P do not adhere or the powders P overlap with each other. Alternatively, when the powders P do not adhere or the powders P overlap each other, the processing may be returned to the previous step, and the powder may be supplied and rubbed again.

The process of supplying the powder, the process of rubbing the powder, and the process of detecting the powder may be performed by moving the powder applicator 830 to the position where the powder supplier 210, the rubbing part 230, or the adherence detector 240 is placed, or by keeping the powder applicator 830 in one place and moving the powder supplier 210, the rubbing part 230, and the adherence detector 240 to the place where the powder applicator 830 is located.

(Effects)

According to the present embodiment thus configured, even when the powder applicator 830 having a cut sheet shape is used, the powder P can be transferred to the resin image R with a simple configuration without supplying the powder P to the powder applicator 830 inside the powder transfer device 800, whereby scattering of the powder P inside the powder transfer device 800 can be suppressed.

### Fourth Embodiment

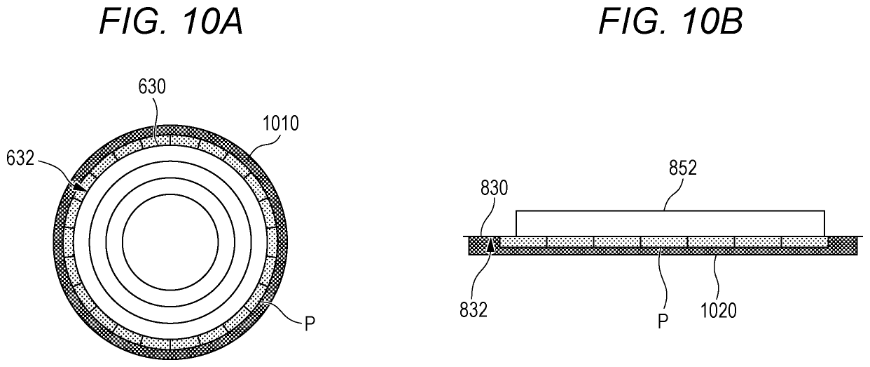

FIGS. 10A and 10B are schematic diagrams illustrating configurations of powder applicators in a fourth embodiment when the powder P is supplied to a powder holding surface by a powder supply device and then the powder applicators are moved from the powder supply device to a powder transfer device. FIG. 10A is a schematic diagram illustrating the powder applicator 630 in which the powder P is supplied to the powder holding surface 632 by the powder supply device 700 in the second embodiment, and FIG. 10B is a schematic diagram illustrating the powder applicator 830 in which the powder P is supplied to the powder holding surface 832 by the powder supply device 900 in the third embodiment.

As illustrated in FIGS. 10A and 10B, the powder applicator 630 includes a protective member 1010 that covers the powder holding surface 632 holding the powder P, and the powder applicator 830 includes a protective member 1020 that covers the powder holding surface 832 holding the powder P. The protective member 1010 and the protective member 1020 cover the powder holding surface 632 and the powder holding surface 832, respectively, to prevent the powder P being moved from coming off. This makes it possible to suppress scattering of the powder P coming off of the powder holding surface 632 and the powder holding surface 832 during movement in the powder transfer device or the powder supply device.

The powder applicator 130 in the first embodiment may also have a protective member to prevent the powder P from coming off of the powder holding surface 132 which is moving.

### Other Embodiments

Note that each of the above embodiments merely shows specific examples for implementing the present invention, and the technical scope of the present invention should not be construed as being limited by the above embodiments. The present invention can be implemented in various modes without departing from the gist or main features of the present invention.

For example, in each of the above embodiments, the resin image is softened by the softener provided on the upstream side of the conveyor with respect to the powder applicator in the conveyance direction. However, a heating device may be disposed inside the roll-shaped powder applicator to heat and soften the resin image from the inside of the powder applicator. In this case, the heating device disposed inside the powder applicator may be moved to the powder supply device together with the powder applicator. Alternatively, the heating device may be removed, and only the powder applicator may be moved to the powder supply device.

In each of the above embodiments, the rubbing part is disposed in the powder supply device. However, the rubbing part may be disposed in the powder transfer device, or another rubbing device may be used to rub the powder.

Similarly, although the adherence detector is provided to the powder supply device in each of the above embodiments, another detector may be used to detect an amount and adherence state of powders held on the powder holding surface.

The powder transfer device and the powder supply device may be disposed in the same decorating device to constitute an integrated image forming apparatus in which the powder applicator is automatically moved, or they may be provided separately and independently. Alternatively, a device forming a resin image and the powder transfer device (and the powder supply device) may be combined to constitute an integrated image forming apparatus.

In the third embodiment, the powder applicator is removed from the powder transfer device and attached to the powder supply device together with the contact member, but only the powder applicator may be removed from the powder transfer device and attached to the powder supply device separately from the contact member. In the second embodiment, the powder applicator may be detached from the powder transfer device and attached to the powder supply device together with the contact member.

In addition, the contact member in the second embodiment and the third embodiment may be formed to promote transfer of the powder to the resin image by pressurization, rubbing, blowing from the contact member which has a mesh form toward the resin image, heating, or the like.

Although the amount and adherence state of powders held on the powder holding surface are optically detected in each of the above embodiments, they may be detected by another method such as a method using a contact type roughness meter.

In addition, the detection result of the surface detector included in the powder transfer device or the adherence detector included in the powder supply device may be fed back to, for example, an amount of powder supplied from the powder supplier in the powder supply device or the strength of rubbing by the rubbing part, and the amount and the strength of rubbing may be changed when the powder is supplied next.

When the powder applicator from which the powder has been transferred to the resin image by the powder transfer device is moved to the powder supply device, and powder is again adhered to the powder applicator, the powder may be adhered again to the powder applicator after the powders remaining on the powder applicator after the previous transfer are removed or may be adhered again without removing the remaining powders. Even if the powder is adhered again without removing the remaining powders, the amount and adherence state of powders are detected by the adherence detector and adjusted, whereby the powders can be held on the powder holding surface in a sufficient amount without being affected by the remaining powders.

Each of the above embodiments describes the configuration in which the powder is applied to the resin image. However, the image may not be the resin image The image to which the powder is applied may be an image formed from a material that is melted or softened by heat, and may be, for example, an image made of metal.

The present invention can suppress scattering of a powder when a decorative image is formed by transferring the powder.

Although embodiments of the present invention have been described and illustrated in detail, the disclosed embodiments are made for purposes of illustration and example only and not limitation. The scope of the present invention should be interpreted by terms of the appended claims

What is claimed is:

1. A powder transfer device comprising:
a holder that detachably holds a powder applicator that applies a powder to an image; and
a transfer part that transfers the powder onto the image from the powder applicator held by the holder,
wherein the powder applicator having the powder adhering to a surface is mounted to the holder.

2. The powder transfer device according to claim 1, wherein the holder holds the powder applicator at a position where the powder adhering to the surface contacts the image.

3. The powder transfer device according to claim 1, further comprising a softener that softens the image, wherein the powder applicator applies the powder to the image that has been softened.

4. The powder transfer device according to claim 3, wherein the softener softens the image by heating.

5. The powder transfer device according to claim 3, wherein the powder applicator holds the powder on a surface having a tack value lower than a tack value of the image that has been softened by the softener.

6. The powder transfer device according to claim 1, wherein the powder applicator has a cylindrical shape.

7. The powder transfer device according to claim 1, wherein the powder applicator has a sheet shape or a web shape.

8. The powder transfer device according to claim 1, wherein the transfer part rotates or moves the powder applicator being held to change a position of the surface of the powder applicator that contacts the image.

9. The powder transfer device according to claim 7, wherein the transfer part includes a contact member that brings the powder holding surface of the powder applicator being held into contact with the image

10. The powder transfer device according to claim 9, wherein the contact member and the powder applicator are integrally attached and detached.

11. The powder transfer device according to claim 1, further comprising a protective member that suppresses the powder from coming off of the powder applicator,
wherein the protective member is detachably mounted to the powder applicator, and is detached from the powder applicator when the holder holds the powder applicator.

12. The powder transfer device according to claim 1, wherein the powder transfer device has no supplier that supplies the powder to the powder applicator.

13. The powder transfer device according to claim 1, further comprising a surface detector that detects a surface state of the powder applicator held by the holder.

14. The powder transfer device according to claim 13, wherein the transfer part does not transfer the powder when the surface detector does not detect the powder on the surface of the powder applicator.

15. The powder transfer device according to claim 13, wherein the transfer part does not transfer the powder when the surface detector detects overlap of the powder adhering to the surface of the powder applicator.

16. A powder supply device that supplies the powder to the powder applicator to be mounted in the powder transfer device according to claim 1, the powder supply device comprising:
a holder that holds the powder applicator; and
a powder supplier that supplies the powder to the powder applicator held by the holder.

17. The powder supply device according to claim 16, further comprising a rubbing part that rubs the powder supplied to the powder applicator.

18. The powder supply device according to claim 16, further comprising an adherence detector that detects an amount or an adherence state of the powder supplied to the powder applicator supplied with the powder.

19. The powder supply device according to claim 18, wherein the powder supplier changes a supplied amount of the powder to the powder applicator according to the amount or the adherence state of the powder detected by the adherence detector.

20. The powder supply device according to claim 18, further comprising a rubbing part that rubs the powder supplied to the powder applicator,
wherein the rubbing part changes a strength of rubbing of the powder according to the amount or the adherence state of the powder detected by the adherence detector.

21. An image forming apparatus comprising:
the powder transfer device according to claim 1.

22. An image forming apparatus comprising:
the powder supply device according to claim 16.
